(19) United States
(12) Patent Application Publication
(10) Pub. No.: US 2009/0276823 A1
(43) Pub. Date: Nov. 5, 2009

(54) METHOD AND APPARATUS FOR MODIFYING A COLOR OF AN ELECTRONIC HOUSING

(75) Inventors: Dean H. Vogler, Algonquin, IL (US); Douglas A. Kuhlman, Inverness, IL (US); Yi Q. Li, Rolling Meadows, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/112,317

(22) Filed: Apr. 30, 2008

(51) Int. Cl. G06F 21/00

(52) U.S. Cl. 726/1

(57) ABSTRACT

A method and apparatus for modifying a color of an electronics housing (104) based on the device security, authentication, and/or authorization is provided herein. During operation a device (100) will repeatedly gather a current security status and then modify a color or pattern of the housing based on the security status. Because the color of an electronics device indicates the current security, authentication, and/or authorization level, a user of the device can easily determine their security, authentication, and/or authorization level.

### FIELD OF THE INVENTION

The present invention relates generally to device security and authentication and in particular, to a method and apparatus for modifying a color of an electronics housing based on the device security and/or authentication.

### BACKGROUND OF THE INVENTION

Computer systems contain sensitive information and resources that must be protected. In order to access these systems, a user/device is generally issued a challenge, and must correctly answer the challenge. For example, email-capable cellular telephones issued to employees are required to be password-protected with a time-based lockout. Gaining entry to these systems often requires keyboard entry. Local programs, such as a GUI configuration/desktop application, require the user to enter their PIN/password to allow the program to run. Remote tasks such as accessing web services, or online stores, require that a user logs in to gain access. A banking application may only allow a user a limited time before the user needs to re-authenticate. For users, it would be nice to know the current status of their authorization on their device; much like a battery meter provides indication on the amount of battery time left. Such a notification would help to reduce “surprise” authentications for the user, since the user could visually know where they stand in terms of security, authentication, and/or authorization. Therefore a need exists for a method and apparatus for easily providing a user the security, authentication, and/or authorization status.

### BRIEF DESCRIPTION OF THE DRAWINGS

FIG. 1. is a block diagram of an electronics apparatus.

FIG. 2. illustrates a housing on a cellular telephone.

FIG. 3. is a flow chart showing operation of the electronics apparatus of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to address the above-mentioned need, a method and apparatus for modifying a color of an electronics housing based on a device security, authentication, and/or authorization is provided herein. During operation the device will repeatedly gather a current security status and then modify a color or pattern of the housing based on the security status. Because the color of an electronics device indicates the current security, authentication, and/or authorization level, a user of the device can easily determine their security, authentication, and/or authorization level.

The present invention encompasses a method for modifying an electronics housing. The method comprises the steps of determining a current security status and modifying a color or pattern of the housing based on the security status.

The present invention additionally encompasses a method comprising the steps of determining a security confidence level of a user and modifying a color or pattern of the housing based on the security confidence level of the user.

The present invention additionally encompasses an apparatus comprising an electronics housing and logic circuitry determining a current security status and modifying a color or pattern of the housing based on the security status.

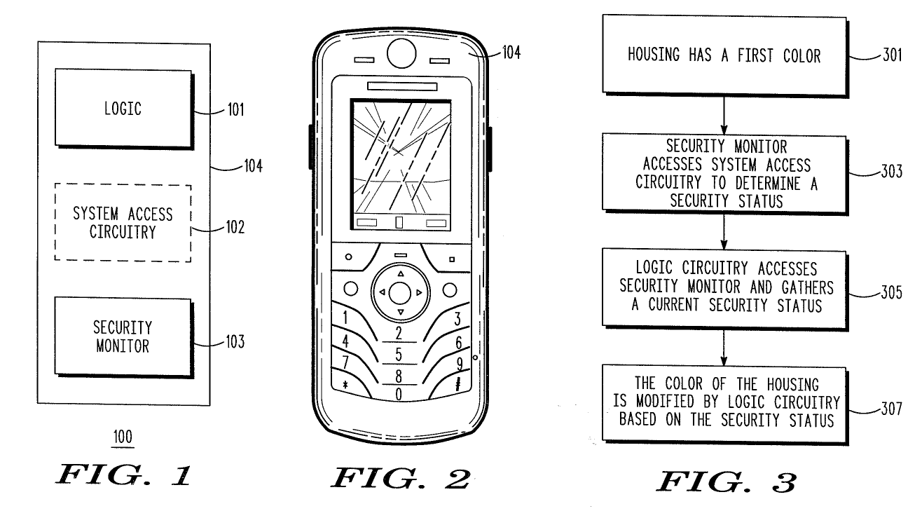

Turning now to the drawings, where like numerals designate like components, FIG. 1 is a block diagram showing an electronics apparatus. As shown, apparatus 100 comprises logic circuitry 101, system access circuitry 102, security monitor 103, and housing 104. Electronics apparatus may comprise any form of electronics that is housed within a housing. For example, apparatus 100 may comprise a cellular telephone (as shown in FIG. 2), an MP3 player, a personal computer, GPS device, television, a personal digital assistant, a set-top box, a wearable device (e.g., watch or special glasses) or even an automobile.

Logic circuitry 101 comprises a digital signal processor (DSP), general purpose microprocessor, a programmable logic device, or application specific integrated circuit (ASIC) and is utilized to accesses and control system access circuitry 102, security monitor 103, and housing 104.

System access circuitry 102 comprises the necessary software and/or hardware to properly authenticate and/or authorize the device for access to an application or computer system. It should be noted that while only one system access circuitry 102 is shown, each computer system or application that device 100 attempts to gain access to may have its own system access circuitry. System access circuitry 102 may exist internal or external to device 100.

As discussed above, email-capable cellular telephones issued to employees are required to be password-protected with a time-based lockout. Gaining entry to these systems often requires entry of a password to system access circuitry 102. Local programs, such as a GUI configuration/desktop application, require the user to enter their PIN/password to system access circuitry 102 to allow the program to run. Remote tasks such as accessing web services, or online stores, require that a user logs in to system access circuitry 102 in order to gain access. System access circuitry 102 may process previously gathered and/or current biometric information (voice, fingerprint, facial recognition, gait, . . . etc.), user behavioral patterns (route tracking, phone call patterns), authentication tokens (wearable device, smartcard token), or PIN/password in order to provide access. The scores returned by the individual biometrics, user behaviors, authentication tokens, or PIN/password during authentication may be combined into a single confidence level, whose value gradually decays over time (similar to the way a capacitor discharges, and described in US20070211923A1 and US20070210895A1, both titled “Method and Apparatus for Combining Outputs for Multiple Systems”, which are encorporated by reference herein.

Security monitor 103 periodically monitors the security status of device 100. For example, depending upon the type of access, security monitor 103 may determine such things as:
whether or not a user has authorization to use a particular computer system or application;
whether or not a user has been authenticated (authentication status);
whether or not a user is “logged in” to an application or computer system;
a confidence level of a user's identification as determined by the accessed system or application, i.e., a degree to which an authenticator trusts the authentication results;
an authentication level, (e.g., whether or not the user of device 100 is properly authenticated or not); or
the security state of the device, as measured by hardware features looking for aberrant processing behavior.

In this particular embodiment, security monitor 103 determines the above by periodically/iteratively accessing system access circuitry 102 to determine the status. For example, there may exist a degradation of the level of access over time (e.g., automatic log-out after no activity for a predetermined period of time) or a decay in the confidence of a user over time. Security monitor 103 monitors and keeps track of changes in access/authorization level.

Housing 104 houses all electronics contained within device 100. In this particular embodiment of the present invention, housing 104 is manufactured from a cholesteric display. As described in APPLICATIONS AND REVIEW OF RIGID AND FLEXIBLE CHOLESTERIC DISPLAYS, by Asad Khan et al., cholesteric displays are bistable reflective liquid crystal displays that have been in the market place for over 10 years. These displays are ideally suited for a wide range of applications—from low resolution signage to high resolution electronic books and readers. The displays use simple low cost passive matrix drive schemes to address large formats. This also enables low cost custom sizing of the display. Other embodiments may include other technologies that allow for alteration of the color of the housing.

As discussed above, it would be beneficial to know the current status of a device's access/authorization level of their device; much like a battery meter provides indication on the amount of battery time left. Such a notification would help to reduce “surprise” authentications for the user, since the user could visually know where they stand in terms of security, authentication, and/or authorization. In order to address this issue, logic circuitry 101 periodically (e.g., once every three seconds) accesses security monitor 103 to determine a current authorization and/or authentication level for a particular computer system or application. Once the security status is known, logic circuitry 101 will access housing 104 and modify a color or pattern of housing 104 based on the security status. Because the color of an electronics device will indicate the current security, authentication, and/or authorization level, a user of the device can easily determine their security, authentication, and/or authorization level. For example, the color of housing 104 may comprise a first color when there is a high confidence level of security and the color of housing 104 may comprise a second color when there is a low confidence level of security. The first and/or second color may comprise a color of the user's preferred choice. Additionally, a range of security confidence levels between a high and a low may be mapped to a color set (colors having attributes such as brightness, tint, and hue, . . . , etc.) between the first color and the second color.

Thus, as described above, as a change in security, authentication, and/or authorization level occurs, housing 104 will continue to morph, from the original (possibly pre-selected) color or pattern, into a second (e.g., an “identity-neutral” color such as gray, black, or white) color or pattern. As the pre-selected color or pattern fades, the user understands that their security level is decreasing, and they may soon have to re-authenticate for an application if requested. If there are passive biometrics in operation, such as background voice verification during phone conversations, then the phone again will automatically morph towards the first color or pattern as the confidence in the user's identity increases.

FIG. 3. is a flow chart showing operation of the electronics apparatus of FIG. 1, and in particular a method for modifying housing 104. Apparatus 100 may have previously performed the steps of FIG. 3 or it might be an initial passage through these steps. Additionally, device 100 may change its security status at any time during the logic flow of FIG. 3.

The logic flow begins at step 301 where housing 104 has a first color. For initial set-up, this first color may be determined by user preference or a device-determined neutral color, as previously discussed. At step 303 security monitor 103 accesses system access circuitry 102 to determine a security status. Logic circuitry 101 then accesses security monitor 103 (step 305) and gathers the current security status. As discussed above, the security status comprises such things as an authentication level of a user (e.g., a degree to which a computer system and/or application trusts a user's authentication), whether or not a user is “logged in” to a computer system and/or application, a security confidence level of a user, . . . , etc. The security status may be obtained by monitoring a user's biometrics to determine a confidence level of the user, monitoring the user's behaviors and inferring a confidence level of the user based on the user's behaviors, . . . , etc.

Finally, at step 307 the color of the housing is modified by logic circuitry based on the security status. As discussed above, the color of the housing can be based on the user's preferred color scheme such that the color of the housing is a first color when a user is properly logged in and/or authenticated and then a second color when the user is not properly logged in and/or authenticated. In a similar manner, a first color may be used when there is a high confidence level in the user's authentication and a second color is used when there is a low confidence level in the user's authentication. A range of confidence levels between high and low can be mapped to a range of colors between the first color and the second color.

The logic flow returns to step 303 where security monitor 103 again accesses system access circuitry 102 to determine (update) a security status, and the logic flow repeats, resulting in a color or pattern of the housing based on the updated security status. This repetition may take place a predetermined number of times, or continuously so that the updated security status is continuously reflected in the color of housing 104. The trigger for the logic flow returning to step 303 could also be the passage of time (e.g., the previously mentioned embodiment of 3 seconds), specific user interaction with the device (e.g., flipping open a cell phone), or other triggers.

While the invention has been particularly shown and described with reference to a particular embodiment, it will be understood by those skilled in the art that various changes in form and details may be made therein without departing from the spirit and scope of the invention. For example, while the above description was given with respect to changing a color of a housing, in an alternate embodiment, the pattern existing on a housing can change in a similar manner. For example, the pattern of housing 104 may comprise a first pattern (e.g., solid) when there is a high confidence level of security and the color of housing may comprise a second pattern (striped) when there is a low confidence level of security. The pattern first pattern is a pattern and/or the second pattern is a pattern of the user's preferred choice. Additionally, a range of confidence levels between high and low are mapped to a pattern set between the first pattern and the second pattern (e.g., a change from pixilated to solid). It is intended that such changes come within the scope of the following claims:

1. A method for modifying an electronics housing, the method comprising the steps of:
determining a current security status;
modifying a color or pattern of the housing based on the security status.

2. The method of claim 1 wherein the security status comprises an authentication level of a user.

3. The method of claim 2 wherein the authentication level comprises a degree to which a computer system and/or application trusts a user's authentication.

4. The method of claim 2 further comprising the step of:
authenticating the user.

5. The method of claim 1 further comprising the steps of:
updating the security status;
modifying the color or pattern of the housing based on the updated security status.

6. A method comprising the steps of:
determining a security confidence level of a user;
modifying a color or pattern of the housing based on the security confidence level of the user.

7. The method of claim 6 wherein the step of determining the confidence level comprises the step of monitoring a user's biometrics to determine the confidence level.

8. The method of claim 6 wherein the step of determining the confidence level comprises the step of monitoring the user's behavior and inferring a confidence level of the user based on the user's behavior.

9. The method of claim 6 further comprising the steps of:
iteratively updating the confidence level of the user;
modifying the color or pattern of the housing based on the updated confidence level of the user.

10. The method of claim 6 wherein the color or pattern of the housing is additionally based on the user's preferred color scheme.

11. The method of claim 6 wherein the color of the housing is a first color when there is a high confidence level and the color of the housing is a second color when there is a low confidence level.

12. The method of claim 11 wherein the first color is a color of the user's preferred choice.

13. The method of claim 11 wherein the first color and the second color is a color of the user's preferred choice.

14. The method of claim 11 wherein a range of confidence levels between high and low are mapped to a color set between the first color and the second color.

15. The method of claim 6 wherein the confidence level comprises a degree to which an authenticator trusts authentication results.

16. The method of claim 6 wherein the pattern of the housing is a first pattern when there is a high confidence level and the pattern of the housing is a second pattern when there is a low confidence level.

17. The method of claim 11 wherein the first pattern is a pattern of the user's preferred choice.

18. The method of claim 11 wherein the first pattern and the second pattern is a pattern of the user's preferred choice.

19. The method of claim 11 wherein a range of confidence levels between high and low are mapped to a pattern set between the first pattern and the second pattern.

20. An apparatus comprising:
an electronics housing; and
logic circuitry determining a current security status and modifying a color or pattern of the housing based on the security status.
